(19) United States
(12) Patent Application Publication
(10) Pub. No.: US 2013/0173062 A1
(43) Pub. Date: Jul. 4, 2013

(54) SMART BUILDING UNIFIED MANAGED SOLUTIONS

(71) Applicant: Pamela Koenig-Richardson, Grapevine, TX (US)

(72) Inventor: Pamela Koenig-Richardson, Grapevine, TX (US)

(21) Appl. No.: 13/454,142

(22) Filed: Apr. 24, 2012

Related U.S. Application Data
(63) Continuation-in-part of application No. 12/653,050, filed on Dec. 8, 2009, now abandoned.

(51) Int. Cl. G05B 13/02

(52) U.S. Cl. CPC G05B 13/02
USPC 700/275

(57) ABSTRACT

The present invention provides a system and method for monitoring and management of operational control systems. The method and system includes receiving a plurality of input data from one or more of a plurality of dissimilar sensors and operations control systems, wherein one or more of the input data being in a data format different from one or more other input data. The system and method conforms the plurality of input data to report status changes in real-time to a unified monitoring system. The method and system enables changes to one or more operational control systems in response to conditional parameters.

### CROSS-REFERENCE TO RELATED APPLICATIONS

The present application is a Continuation-in-part, based on, and claims priority to U.S. patent application Ser. No. 12/653,050, filed on Dec. 8, 2009.

### BACKGROUND

The present invention relates generally to data processing and management systems, and more specifically to the processing and management of building or facility management systems.

Technical, facility, transportation, utility, public safety, and other operations rely on a variety of dissimilar management, surveillance, and control systems particularly designed to provide status indications and supervisory control to designated personnel or automatic systems that manage and/or survey both manned and unmanned electronic and electromechanical subsystems' health and productive efficiencies, and/or sense and survey public and private spaces to enhance the safety and security of people and property. These dissimilar management, surveillance, and control systems are generally specifically produced to interface with goods and services provided by a particular manufacturer or systems integrator, and are applicable only to a narrow range of subsystems or related software applications.

The narrowness of these particular systems and software applications in supervisory status, surveillance, and control human/machine interfaces hamper effective recognition and response to emergent conditions that may require human intervention and/or automatic remediation. Many of the qualities of these emergent conditions are not readily apparent to supervisory personnel, either because of the confusing or mind-numbing deluge of data produced in a real-world environment, or because information can only be derived from a multiplicity of dissimilar data sources, and cannot be readily interpreted without cognitive analysis too complex and/or time consuming to be reliably and continuously performed by human operators.

Various electronic or electromechanical resources and data sources including but not limited to heating, cooling, power, water control, security and surveillance systems, elevators, lighting, fire detection and suppression systems, and telecommunication systems, may have their own status indicators, management controls, or surveillance displays. While it's theoretically possible to assign personnel to each such unique supervisory, surveillance, and/or control interface, this isn't done because of practical limitations due to the diversity of such systems; the benefits that can be derived from emergent relationships between such systems are concealing by the sheer volume of inconsequential data, and by the relatively low incidence of a need for manual intervention in the operation of each system or need to dispatch personnel to remediate a wasteful or hazardous condition or security threat in contrast to the cost of personnel necessary to operate all interfaces simultaneously. Moreover, the present proprietary nature of each unique supervisory, surveillance, and/or control interface results with dissimilar operational processes and procedures requiring a high degree of technical specialization to manually operate. As such, the cost of cross training personnel to simultaneously operate all such subsystems is prohibitive. Even if such training were feasible, the emergent qualities of cross system analysis and control could not be achieved.

### SUMMARY

The present invention relates generally to data capture and conformity from, and control of, diverse and dissimilar devices, security and surveillance systems, and electromechanical systems and subsystems for the purpose of supervisory management, personnel training, and records management. The invention applies to systems collective control paradigm inclusive of all centers of human and autonomic activity including but not limited to commercial and industrial buildings and complexes; residential housing and complexes; hotels, amusement parks, and zoos; medical facilities; municipal lighting and irrigation systems; farming irrigation; water and wastewater treatment; utility infrastructures such as water, power, natural gas, and combined heat and power delivery systems, and electrical grid management; manufacturing, mining, and material processing plants; power plants including coal, wind, solar, gas turbine, diesel generator; hydrogen fuel cell, nuclear, and other facilities and infrastructures; information, data, and telecommunications facilities and infrastructures such as telephonic, video, and wireless, terrestrial, and satellite data networks, computer centers and other facilities; and public and private transportation systems including but not limited to ships, airports, spaceports, aircraft, spacecraft, subways, roads and highways, rail infrastructure, trains, trams, vehicular operations, and fleet management.

The system and method provides for monitoring a diverse multiplicity of dissimilar real-time digital and analog sensory data sources for incorporation into a universal interactive information display and supervisory control resource. The system and method includes software algorithms for recordation of sensory data input for later analysis, evaluation, and personnel training and education purposes; and to provide for simulation of routine and emergency events for the purpose of personnel education and training.

The system and method normalizes the plurality of input data to generate conformed and normalized sensory data; processes the normalized data to detect and display operational status; and continuously monitors the systems in relation to each other dissimilar system based on comprehensive plurality of input data. Thus, this method and system, in response to conditional parameters, enables manual or automatic change or control of a multiplicity of dissimilarly manufactured and purposed operational control, surveillance, and data acquisition systems.

Examples of the benefits of real-time autonomic cross-systems analytic response enable by this system, method, and invention include, but are not limited to, cost effective power consumption and operation of various appliances in an “Internet of Things” including street and pathway, external, and internal lighting, interior heating and cooling controls, escalators, and transportation systems availability and operation; facilities access controls dependent on the identity and proximity of authorized or suspicious persons and other individuals; real-time facility and network intrusion detection including behavioral anomalies and recognition of specific or suspicious vehicles, persons, weapons, or containers; and recognition of emergent conditions necessitating response and enhancing such response with tactical command and control including, but not limited to, intruder interception, automatic fire control and suppression, designated safe routes for emergency entry and evacuation with smoke diversion or remediation; and first responder identification and location with combined access controls and distributed visual situational awareness under the supervision tactical control of remotely distributed command personnel.

### BRIEF DESCRIPTION OF THE DRAWINGS

FIG. 1 illustrates an architectural view of a system for facility management.

FIG. 2 illustrates one embodiment of a system for facility management.

FIG. 3 illustrates a further detailed view of one embodiment of facility management system.

FIG. 4 illustrates a flowchart of the steps of one embodiment of a method for facility management.

FIG. 5 illustrates a facility-side processing system for the facility management system.

FIG. 6 illustrates a management-side processing system for the facility management system.

### DETAILED DESCRIPTION OF PREFERRED EMBODIMENTS

Exemplary embodiments of the present invention will hereinafter be described in detail with reference to the accompanying drawings. These embodiments provide systems and methods for monitoring and management of a building having operational control systems, as described below.

A software neural network comprised of a community of agents acts independently and on behalf of program authority to decide if (and which of many) actions are appropriate on the basis of self-determined heuristics. The Agency is not invoked for a task but is instead capable of independent action and anticipation based on continuous sensory and data analytics to control and moderate power consumption in the delivery of environmental and building services, energy consumption and efficiencies, lighting, SCADA, communications, Power, operations, facilities, fire, video, green environmental conditions, physical intrusion detection and security measures, network and infrastructure status awareness, and maintenance scheduling. The system incorporates an Information Fusion Engine as its machine/human interface to more fully expose information in human understandable format.

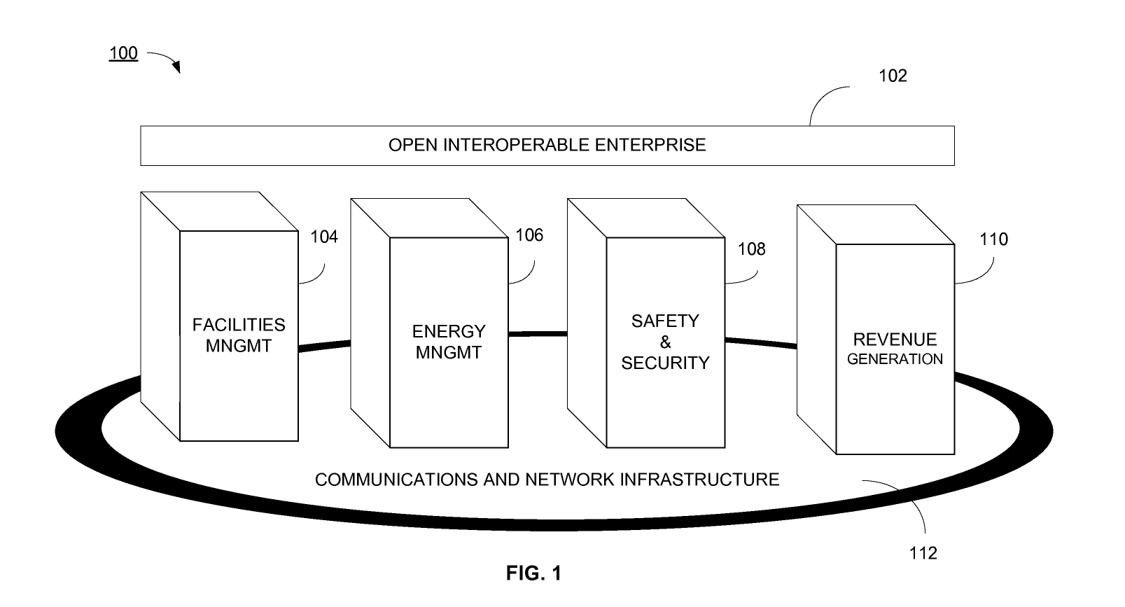

FIG. 1 illustrates one generalized embodiment of a smart building unified managed solution system 100. The system includes an open interoperable enterprise 102 and resource processing systems including facilities management 104, energy management 106, safety and security 108 and revenue generation 110. These resource processing systems are further integrated via a communications and network infrastructure 112.

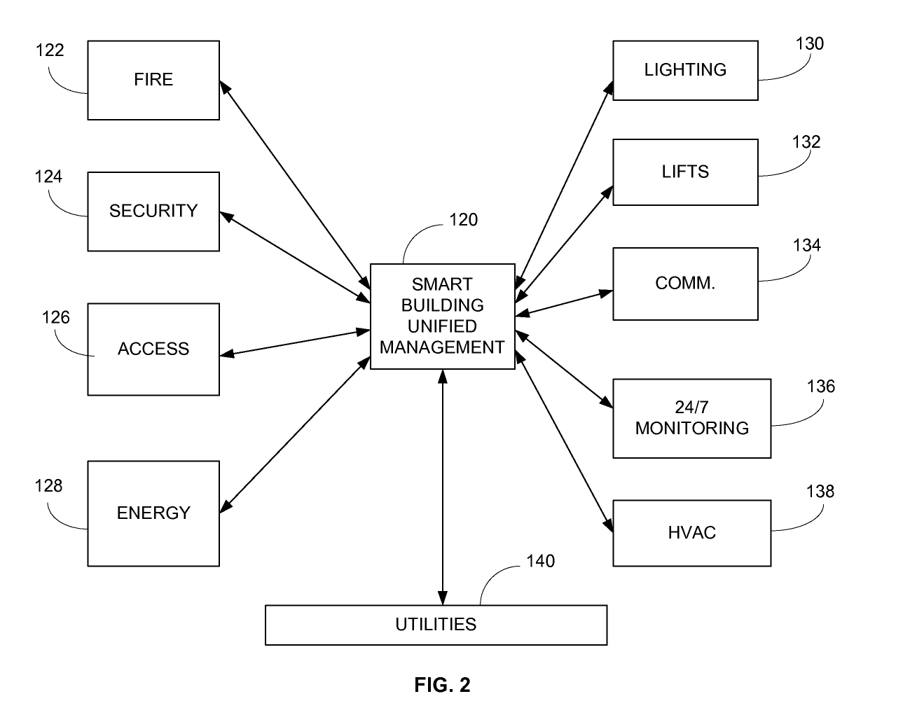

While FIG. 1 illustrates a much more generalized system, FIG. 2 illustrates another instantiation describing the smart building unified managed solutions system 120. FIG. 2 illustrates further exemplary processing components and systems for the facilities management. In this exemplary embodiment, the system communication with a fire system 122, a security system 124, an access system 126, energy system 128, lighting system 130, lift system 132, communication system 134, monitoring system 136, heating, ventilation and air conditioning (HVAC) 138 and utility systems 140.

For example, the fire system 122 includes functionality checks, detector services, fire, life and safety systems, as well as other monitoring and/or detection components. The security system 124 includes sensor fusion, scene awareness, decision aids, protection systems, integration and business continuity, as well as other monitoring and/or detection components. The access system 126 includes door and building sensors, perimeter occupancy in feed forward systems, as well as other monitoring and/or detection components. The energy systems 128 include utility monitoring, ventilation, management, heating management cooling management lighting and back generation, as well as other monitoring and/or detection components.

Lighting systems 130 include schedules and occupancy sensing, as well as other monitoring and/or detection components. Lift or elevator systems 132 include breakdown, maintenance and traffic performance, as well as other monitoring and/or detection components. Communication systems 134 include voice, video, and data collaboration tools, as well as other monitoring and/or detection components. Twenty-four/seven monitoring systems 136 include breakdown, plant tuning, condition monitoring and car park utilization, as well as other monitoring and/or detection components. HVAC systems 138 include air handling units boilers pumps fans energy control variable air volume and air quality control systems, as well as other monitoring and/or detection components. Utilities 140 generally relate to applicable utilities and utility systems including but not limited to water, electricity, sewer, gas, among others. As illustrated in this embodiment, the building and facility management described herein extends beyond the facility itself and is interactive with outside additional control systems, including for example the utility systems. Moreover, it is recognized that using the system described herein, the facility management is a plug-n-play system allowing for integration of varying systems, sensors, devices, monitoring devices and any other system or component for monitoring activities.

FIG. 2 further illustrates the smart building unified management processing center 120 which is a software neural network comprised of a community of agents that act independently and on behalf of program authority to decide if (and which of many) actions are appropriate on the basis of self-determined heuristics for the facility operators. The processing system 120 is not invoked for a task but is instead capable of independent action and anticipation based on continuous sensory and data analytics to control and maintain appropriate power consumption in the delivery of environmental and building services. This represents the computational processing controlling and maintaining all aspects of the facility.

At predetermined intervals the processing system 120 performs an action and the environment generates an observable condition with an instant cost in accordance with an unknown dynamic. The processing system 120 interacts with its control infrastructure to discover and validate policies for selecting actions that minimizes some measure of a long-term cost, i.e. the lowest expected cumulative cost. The process continues over time until equilibrium is firmly established, and thereafter occasionally challenges its own policies to validate continuing assumptions. While environmental dynamics may be subject to change over time (seasonal variation), short interval changes (rooms not always occupied), and the long-term cost for each policy are unknown at inception, the processing system 120 learns from its actions, as described in further detail below, to construct, refine, and challenge policies (heuristics) to deliver the most optimal result regardless of building configuration or reconfiguration, human behavior, and seasonal variations.

While FIG. 2 illustrates representative systems, it is understand that additional systems are also within the scope of the present invention. These additional systems may include all or any combination of the following and other systems and services: HVAC, surveillance, security, elevator, escalator, interior and exterior lighting, fire detection and suppression, smoke evacuation, chemical and radiation detectors, chemical and radiation isolation systems, perimeter sensors, door locks, biometric and coded access controls, proximity detectors and access controls, point of sale registers, fans, air flow control apparatus, window shades, floor illuminators, manufacturing and packaging systems, robotic material handling and stock management systems, public transportation systems, alarms, public address systems, prerecorded public information messages, electronic signs, geographical location and information systems, biometric monitors and status indicators, thermal imaging and radar systems, facial recognition systems and databases, infrared and sonic detection systems, wireless and terrestrial telecommunication systems, physical and network intrusion detection systems, environmental and electrical status indicators and controls, power consumption monitors, backup generators, on-site power conditioning and power generation systems, vehicular management and parking, sound systems, supervisory control and data acquisition systems, window openers/closers, irrigation systems, water coolers and heaters, pool heaters and temperature controls, pond temperature controls, animal containment environmental controls, animal feeders and water supplies, analog power indicators, vehicular barricades and entry/egress controls, license plate readers, video and radar analytic systems, video and audio recorders, linguistic transcription and translation systems, wireless networks, and among others.

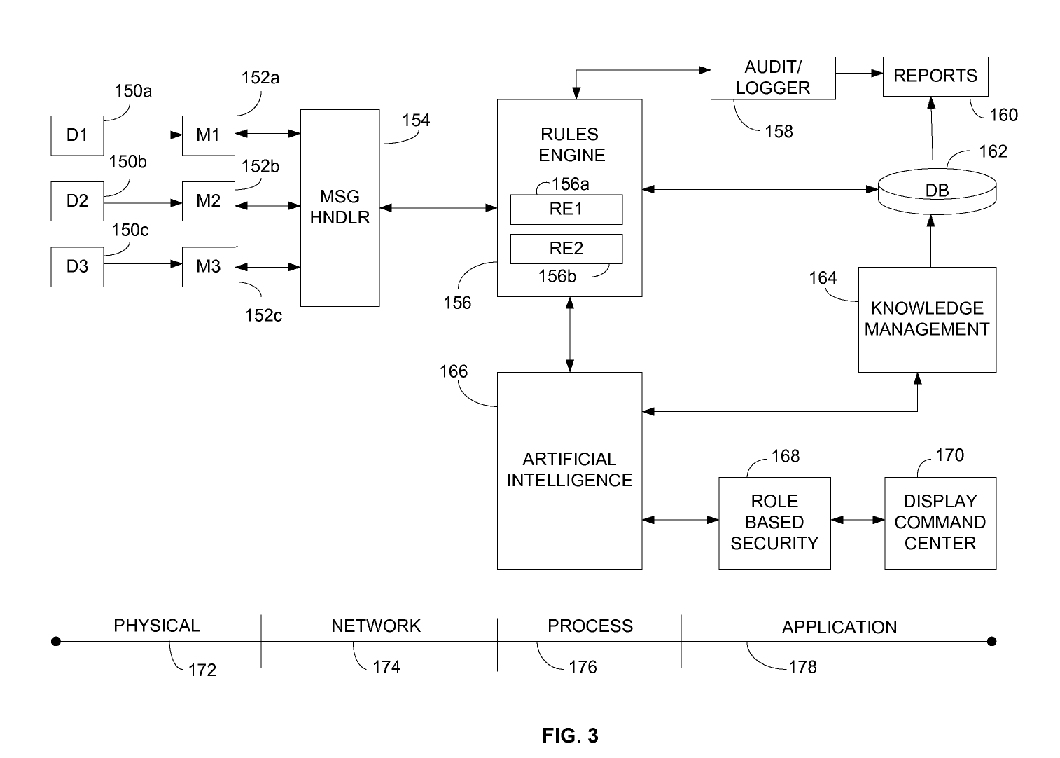

FIG. 3 illustrates a more detailed illustration of operational components of the management system described herein. The system includes a plurality of sensors 150a, 150b and 150c, message handlers 152a, 152b, 152c, common message handler 154 and a rule engine system 156 including a first rule engine 156a and a second rule engine 156b. The system includes an audit/logger 158 and a reporting module 160, as well as database 162. The system also includes a knowledge management device 164, artificial intelligence processing device 166, a role based security device 168 and a display command center 170.

As further illustrated in this embodiment, the bottom bar of FIG. 3 illustrates various components in the physical spectrum 172, the networking spectrum 174, the processing spectrum 176 and the application spectrum 178.

The above components provide for functionality as described herein. The illustration of FIG. 3 is an exemplary embodiment, but it is recognized by one skilled in the art that additional elements may be included in the processing system, including for example additional devices and/or sensors 150. Moreover, the illustration of FIG. 3 may be across a distributed environment including the communication across networked connections for communication, including using additional communication protocols and communication techniques recognized by one skilled in the art.

In the system of FIG. 3, the devices and/or sensors 150 are operative to detect and/or collect information. For example with reference to the system of FIG. 2, the sensors may be in one of the various systems, such as the fire system 122 or the security system 124. The devices/sensors 150 operate using their own internal protocols for not only collecting data, but also reporting the data. These protocols are inconsistent between different detection systems. Each device 150, upon recording and/or reporting data, provides such data in its internal protocol to the corresponding message handler 152. It is noted that the illustrative embodiment of FIG. 3 shows 3 sample devices 150a, 150b, and 150c and message handlers, 152a, 152b, and 152c, any suitable number of devices 150 and handlers 152 may be utilized.

The handlers 152 process the message to a common message handler 154. The common message handler 154 translates the device-specific protocol into a generalized protocol, thereby conforming the input data of the device 150 to generate usable data. In one embodiment, the common message handler 154 includes a plurality of translation tables to translate the data into conformed data, whereby the translation table includes the various device-specific information and a corresponding conformed data value.

The handler 154 thereby communicates with the rules engine, shown generally as 156. In this embodiment, there are two rule engines 156a and 156b, each including various rules for processing the business data translated into the common protocol. The communication between the rules engine 156 and the handler 154 may be across a networked connection.

The rules engine 156 communicates with an audit/logger processing device 158. This device 158 can audit and log the conformed data and is operative to generate a report 160 detailing activities detected by the devices/sensors 150 and the actions proscribed by the rules engine 156.

The rules engine 156 additionally logs data via the database 162, which is usable for the reports 160. Moreover, the rule engine 156 may access the database 162 for further processing the rules, as necessary.

The engine 156 communicates with an artificial intelligence processing component 166. The artificial intelligence engine 166 communicates with a knowledge management system 164 for generating database storage and reporting 160. Additionally, the knowledge management system 164 allows for the artificial intelligence system 166 to iteratively learn and improve the facility management. The artificial intelligence system 166 learns from the iterative process of processing the conformed data and the resultant operations in the facility as detected by additional device/sensor 150 outputs.

In one embodiment, the device 166 thereby generates an action or instruction for the facility management. This instruction may be processed back through the processing system to the facility for implementation. For example, if a detector senses a lack of movement in an area of a building, the artificial intelligence 166 may instruct the reduction of air condition airflow to that particular region to converse power. The engine 166 may also generate actionable instructions or output for a user or controller.

In one embodiment, a filtering component 168 filters viewing of the facility information based on security clearance. This may use standard security and filtering techniques to restrict access to facility data to designated users. In the system of FIG. 3, an additional output is a display command center 170 that provides a visual and/or audio output for the monitoring of the facility. For example, this command center 170 may include video and/or audio access to areas of the facility as well as the data received from the devices/sensors 150. In another embodiment, the command center 170 may include processing capabilities for instructions for managing the facility. By contrast of the above example of an automated reduction or disabling of air conditioning, the use of the command center may make it user-controllable. Therefore, in one example, the user operating the command center 170 can receive information about the power consumption of a vacant area of the facilities and could then provide user controls to manually disable or reduce various levels of power consumption including reducing air conditioning and shutting off lights or other electricity consuming components.

As also illustrated in FIG. 3, the system of FIG. 3 is divided into four spectrums. The physical spectrum 172 includes the devices/sensors 150 and the handling devices 152 for processing the device/sensor data. The networking spectrum 174 provides for the translation of the protocols to a conformed data protocol and communication to the rules engine 156. The processing spectrum 176 includes data processing and calculations for not only processing but iterative learning from the facility data. The fourth spectrum, the application spectrum 178, provides computer processing operations aspects as well as user interaction including the command center 170, as well as report generation 160.

In one embodiment, devices could be sensory devices that are capable of capturing the state and communicate using a specific vendor protocol to the message handlers. Message handlers communicate messages and state information to the common handler, where all different types of protocols are converted to a common protocol or language. These common messages are processed by the rules engine. For various modules of the building management system, the energy management system and power management system, there are modules/clusters of rules engines available to make the system economic and efficient. The rules engine feeds the audit data, logging and also updates the database with the necessary data.

The results from the rules engine are processed by a specific artificial intelligence module to see if an already realized solution is available based on the state or the problem. The artificial intelligence gets input from the knowledge management device and the configuration setup. Based on its determination, the artificial intelligence module sends the user a display for an actionable item or an informational item. Also, these actions may be dependent on the role based security module. Any new action by the user will be learned and stored by the artificial intelligence module into the knowledge management system. This makes the whole system self sustainable, secure, and requiring less manual intervention to achieve maximum security and efficiency, integration of building management system, EMS, PMS and NMS all together into one operating system.

In another embodiment, the system provides integrating real-time data from a multiplicity of dissimilar electronic and electromechanical devices for the purpose of presenting, recording, and simulating for training purposes, information in a format most readily understandable to human operators so that may be quickly aware of, and most responsive to, events, alerts, and conditions that may require immediate, or scheduled, human intervention or other operator initiated action(s) including administration and maintenance activities. The system and processing method incorporates a multiplicity of computational services to automatically (a) acquire data messages from dissimilar source devices; (b) read, structure, format, and classify the content of discrete and/or streaming messages so as to conform useful data to an extensible language format capable of being automatically input and recorded by means of a relational database, or, as in the case of streaming media, input metadata to a database concurrently as streaming media is recorded by means of a non-volatile memory for future use by utilizing metadata to search for, identify, locate, and validate recorded streaming media as needed; (c) concurrently format data for immediate graphical display to human operators; (d) provide for concurrent streaming media display of the subject data source devices and wells as relevant results of the operation of the subject data source devices that may include, but are not limited to, water flow rates, air flow, temperature, pressure, humidity, stability, noise level, audio frequency, and vibration; (e) provide for the display and control of surveillance, access control, inventory management, and personnel locators. Such systems may include, but are not limited to, electrically actuated door locks, magnetic card-key readers, mobile Radio Frequency Identification systems, and mobile geographic location devices, for display on a geographically contextual map or building diagram display; and (f) recording and displaying simulations of conditions that may precipitate events, alerts, and that may necessitate action(s) on the part of operators for the purpose of providing training and exercises to facilitate operator readiness to respond to such events, alerts, and conditions.

Data in any format is acquired from any of a multiplicity of devices, dissimilar in terms of make, model, manufacturer, and function utilizing Universal Serial Bus, WiFi, WiMAX, Cellular Data, Blue Tooth, Ethernet, Data Radio, Serial, Parallel, or other data transmission modality. The connection is made, initiated, or maintained by means of keep alive, session initiated protocol, polling, associated server interface, or any other method more particularly applicable to any such device.

Process 1 (Message Handler) may be executed by one or more computers as needed. In Process 1, Source devices are identified by mean of port address, MAC address, IP address, embedded serial identifiers, data strings, or any other unique identifier. All useful data is translated as necessary and coded for parsing by Process 2 (Record Logger) and Process 4 (Relational Database) in the form of UCD strings (generally utilizing structures such as derivations of XPath with VTD, or such other structures as may be most suitable for high-speed schema-less parsing and/or data binding) inclusive of the means of identification, unique source identifier, date and time of capture, all relevant state messages, alarms, event indicators, status indications, text, metadata, and binaries, as applicable, depending on the data source device and attributes.

Process 2 (Record Logger) may be executed by one or more computers as needed. In Process 2, Process 1 messages are compared to the previous message from the subject device. Repetitive metadata and test strings are replaced with a place holder string indicating that no change in message content was received. Changes of state and numerical quantifications are faithfully reproduced, and a record is generated with a Process 2 time stamp for distribution to Process 3 (State Reporter) and Process 4 (Relational Database).

Process 3 (State Reporter) may be executed by one or more computers as needed. State Reporter updates and transmits only those fields required by Process 5 (GUI Generator) and/or heuristic engine and/or artificial neural network, to present the subject information in a format readily assimilable by a human operator using either a web browser, a purpose-built graphic application, or both (GUI Generator), and in a format consistent with the needs of an interface to a heuristic engine and/or artificial neural network(s). Device sources and data points are matched and identified with fields anticipated by the GUI Generator and/or heuristic engine and/or artificial neural network(s).

Process 4 may be executed by one or more computers as needed. This is a Relational Database that may consist of any commercially available high speed database engine capable of parsing UCD.

Process 5 (GUI Generator) consists of a web browser or computer workstation application with suitable plug-ins to enable display of streaming data, or a graphical application capable of suitably formatting a visual information display as process flow graphics, video and audio displays, map or building graphics, and incorporating multiple monitors as needed.

Process 6 (Report Generator & Timeline Simulation Generator) consists of a purpose built software report generator or a commercially available report generator, running in one or more computers as needed, in combination with a purpose-built timeline control application (Timeline Application). The Timeline Application provides for drag and drop event, alert, and condition updates that may be manually or automatically produced to simulate real-time events for training purposes. During such exercises, the Timeline application interfaces with Process 5 (GUI Generator) and performs the same functionality as Process 3 (State Reporter) with the exception that real-time information displayed is acquired from a predetermined database simulation rather then real-time data acquired from Process 2 (Record Logger).

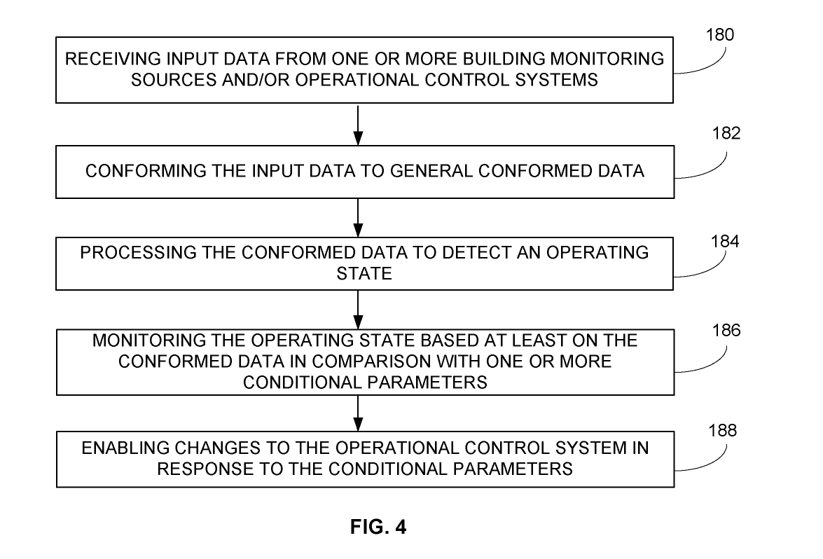

The method of monitoring and management of a building having operational control systems is illustrated in the flowchart of FIG. 4. In this exemplary embodiment, a first step, step 180, is receiving input data from one or more of a plurality of building monitoring sources and operational control systems, wherein one or more of the input data being in a data format different from one or more other input data. The input data may be from any of the noted sources in FIG. 2, as well as other sources recognized by one skilled in the art.

In the illustrated embodiment of FIG. 4, a next step, step 182, is conforming the input data to general conformed data. Normalization operations provide for the disparity of data types generated from the varying data sources. Therefore, based on the normalization, for example, the fire control system data may be usable concurrent with the energy and lighting systems.

A next step, step 184, is processing the conformed data to detect an operating state of a building. The processing of the conformed data is processed relative to a plurality of operational standards and operational comparative algorithms. The processing system may include existing or anticipate state values for relations between the varying processing systems and based on the comparison of the processed normalized data to operational state values or parameters, the system can then determine the corresponding operating state of the building.

In the embodiment of FIG. 4, a next step, step 186, is monitoring the operating state of the building based on the conformed data. Monitoring operations may be conducted consistent with standard monitoring operations, including setting a plurality of range values for optimized, or even acceptable performance. Monitoring may include comparing the building data with the range values for determination of any variance outside of acceptable levels.

Therefore, in the embodiment of FIG. 4, a next step, step 188, in response to conditional parameters, the method includes enabling changes to one or more building operational control systems.

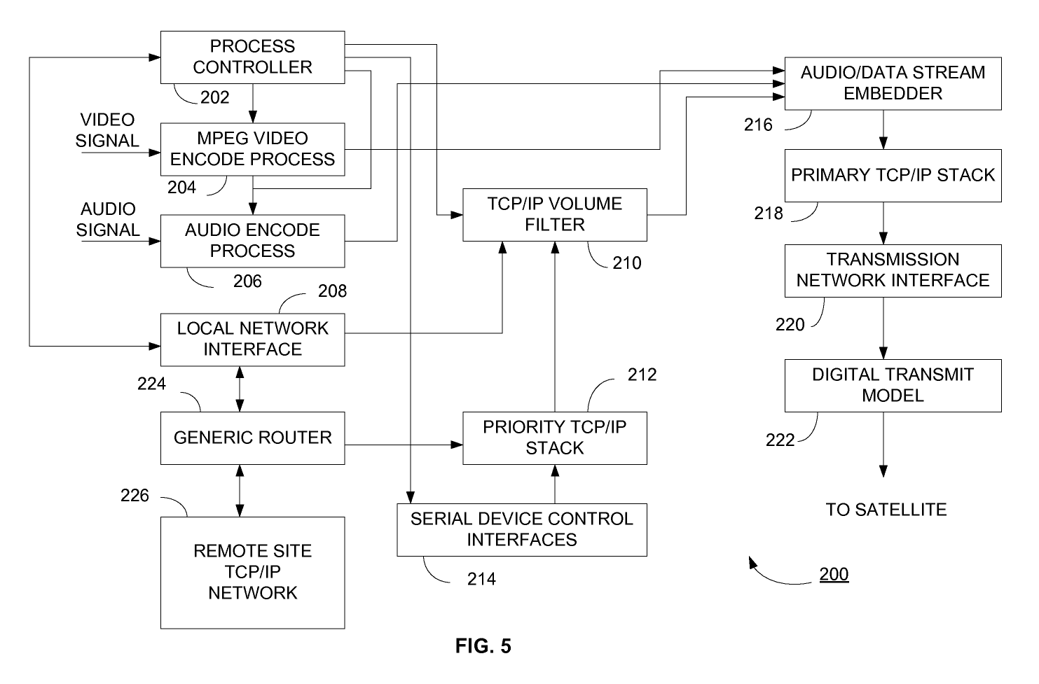

FIG. 5 illustrates a functional schematic drawing of a computerized digital video encoder/compressor 200 in the system for building management. The system 200 represents the transmission out of the building or facility to a central processing system. The schematic consists of a Process Controller 202, MPEG Video Encoder Process 204, Audio Encode Process 206, Local Network Interface 208, TCP/IP Volume Filter 210, Priority TCP/IP Stack 212, Serial Device Control Interface 214, Audio/Data Stream Embedder 216, Primary TCP/IP Stack 218 and Transmission Network Interface 220. Moreover, the data is transmitted via a digital transmission device 222. The local network interface 208 further communicates with a generic router 224, which communicates with a remote site TCP/IP network 226. In this embodiment, the transmission is illustrated as a satellite transmission, but may be any other suitable transmission means recognized by one skilled in the art. FIG. 5 illustrates one embodiment of a site-based processing component for detecting facility activity, as well as processing and communicating via the digital transmit model.

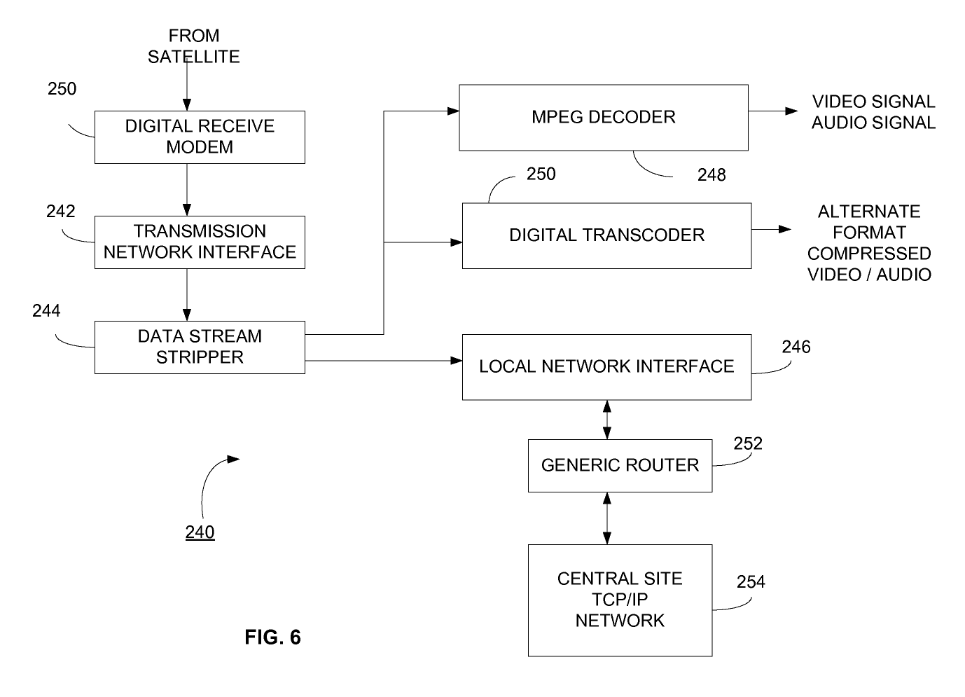

FIG. 6 illustrates a corresponding computerized digital video decompressor/decoder and/or transcoder 240. The system 240 is operative to receive the data transmitted from the system 200 of FIG. 5 for the performance of building management processing operations. The system 240 includes transmission network interface 242, data stream stripper 244, local network interface 246, and MPEG Decoder 248, an optional Digital Transcoder 250. The system further includes a modem 250 to receive the incoming data, as well as a generic router 252 and a control site TCP/IP network 254. Thus, the system 240 provides for the receipt on front end processing of facility data usable for the knowledge management and artificial intelligence systems described above.

Therefore, the unified building management allows for optimized operations of the facilities based on varying situations and considerations. Considerations include seasonal and daily thermal load characteristics required to maintain uniformity of environmental conditions in occupied spaces; anticipation of room environmental control activation by means of analysis of existing community schedules and behaviors; actuation and deactivation of lighting, data appliances, and additional support infrastructure as determined by direct real-time machine sensory observation of actual temperature, lighting, and physical occupation; behavior analytics for entire systems with additional behavior analytics for energy modeling tool to determine optimal energy efficiencies and automatically perform modifications to the system to achieve the optimal energy consumption; and other considerations as recognized by one skilled in the art.

FIGS. 1 through 6 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for monitoring and management of operational control systems, the method comprising:
receiving a plurality of input data from one or more of a plurality of building monitoring sources and operational control systems, wherein one or more of the input data being in a data format different from one or more other input data;
conforming the plurality of input data to generate usable data;
processing the conformed data to detect an operating state;
monitoring the operating state based on the conformed data and state information; and
enabling changes to one or more operational control systems based on the monitoring of the operations.

2. The method of claim 1 further comprising:
processing the conformed data to generate maintenance data; and
storing the maintenance data in a database.

3. The method of claim 2 further comprising:
based at least in part on the building maintenance data, enabling changes to one or more building operational control systems to optimize building operations.

4. The method of claim 3 wherein optimized building operations include at least one of: lighting, heating, cooling, security, and power consumption.

5. The method of claim 2 further comprising:
performing a timeline simulation of building events based on the building maintenance data; and
generating feedback data for monitoring the operating state of the building.

6. The method of claim 1 further comprising:
monitoring the operating state of the building to detect an alert condition; and
generating a warning notification in response to the alert condition.

7. The method of claim 1 further comprising:
receiving one or more of the plurality of input data in a continuous feed; and
monitoring the operating state in a real time.

8. The method of claim 1 further comprising:
receiving the plurality of input data across one or more transmission modalities.

9. A computerized system for monitoring and management of a building having operational control systems, the method comprising:
a computer readable medium having executable instructions stored thereon; and
a processing device, in response to the executable instructions, operative to:
receiving a plurality of input data from one or more of a plurality of building monitoring sources and operational control systems, wherein one or more of the input data being in a data format different from one or more other input data;
conform the plurality of input data to generate usable data;
process the conformed data to detect an operating state;
monitor the operating state based on the conformed data and state information; and
enable changes to one or more operational control systems based on the monitoring of the operations.

10. The system of claim 9, the processing device further operative to:
process the conformed data to generate maintenance data; and
store the maintenance data in a database.

11. The system of claim 10, the processing device further operative to:
based at least in part on the building maintenance data, enable changes to one or more building operational control systems to optimize building operations.

12. The system of claim 11, wherein optimized building operations include at least one of: lighting, heating, cooling, security, and power consumption.

13. The system of claim 11, the processing device further operative to:
perform a timeline simulation of building events based on the building maintenance data; and
generate feedback data for monitoring the operating state of the building.

14. The system of claim 9, the processing device further operative to:
monitor the operating state of the building to detect an alert condition; and
generate a warning notification in response to the alert condition.

15. The system of claim 9, the processing device further operative to:
receive one or more of the plurality of input data in a continuous feed; and
monitor the operating state in a real time.

16. The system of claim 9, the processing device further operative to:
receive the plurality of input data across one or more transmission modalities.

17. A tangible computer readable storage medium containing a software program for monitoring and management of a building having operational control systems, the storage medium comprising:
computer program code for receiving a plurality of input data from one or more of a plurality of building monitoring sources and operational control systems, wherein one or more of the input data being in a data format different from one or more other input data;
computer program code for conforming the plurality of input data to generate usable data;
computer program code for processing the conformed data to detect an operating state;
computer program code for monitoring the operating state based on the conformed data and state information; and
computer program code for enabling changes to one or more operational control systems based on the monitoring of the operations.

18. The storage medium of claim 17 further comprising:
computer program code for processing the conformed data to generate maintenance data; and
computer program code for storing the maintenance data in a maintenance database.

19. The storage medium of claim 18 further comprising:
computer program code for, based at least in part on the building maintenance data, enabling changes to one or more building operational control systems to optimize building operations.

20. The storage medium of claim 19 wherein optimized building operations include at least one of: lighting, heating, cooling, security, and power consumption.
